(19) United States
(12) Patent Application Publication
(10) Pub. No.: US 2014/0373673 A1
(43) Pub. Date: Dec. 25, 2014

(54) MACHINE TOOL HAVING EXTENDABLE COVER

(71) Applicant: FANUC Corporation, Yamanashi (JP)

(72) Inventor: Akihiko NAGAO, Yamanashi (JP)

(21) Appl. No.: 14/311,950

(22) Filed: Jun. 23, 2014

(30) Foreign Application Priority Data
Jun. 24, 2013 (JP) 2013-132090

(51) Int. Cl. B23Q 11/08

(52) U.S. Cl. CPC B23Q 11/0825
USPC 74/608

(57) ABSTRACT

A machine tool has a telescopic cover. One end of the telescopic cover is fixed to the machine tool via a cover supporting member. In the cover supporting member, through holes through which fixing bolts pass are formed on a surface to be fixed to the telescopic cover and a surface to be attached to the machine tool. Gaps between the through holes and fixing bolts are used to adjust the attachment position of the cover supporting member with respect to the machine tool and the position of the telescopic cover with respect to the cover supporting member.

### BACKGROUND OF THE INVENTION

1. Field of the Invention

The present invention relates to a machine tool having an extendable cover.

2. Description of the Related Art

For a machine tool, to prevent chips generated during machining from accumulating on components such as ball screws that drive a table, saddle, or column, a technique by which an extendable cover (telescopic cover) is provided to cover these components is disclosed in Japanese Patent Application Laid-Open No. 7-60593 and Japanese Patent Application Laid-Open No. 2003-236731.

When a telescopic cover is provided in a machine tool, the telescopic cover typically has a configuration in which one end (fixed end) of the cover is attached to a table, saddle, or column, and the other end (moving end) is attached to a saddle or bed.

To operate the machine tool efficiently, the sections of the machine tool are made to work at a high speed. During a task of installing the telescopic cover on the machine tool, the position of the telescopic cover may not be adjusted properly and the telescopic cover may be fixed to the machine tool in a state in which the telescopic cover is twisted between one end (moving end) and the other end (fixed end). In this case, a plurality of covers that constitute the telescopic cover rub against each other, and cover extension and contraction cannot be made smoothly to track axial movement of the machine tool. Therefore, to mount the telescopic cover such that cover extension and contraction can be made smoothly to track axial movement of the machine tool, the adjustment of the position of the telescopic cover is essential when the telescopic cover is mounted.

FIGS. 18A to 18C illustrate a method of mounting a conventional telescopic cover.

In the machine tool, ends of a first telescopic cover 9 and a second telescopic cover 10 are fixed to opposite sides of a table 5 supported on a saddle 6. The first telescopic cover 9 includes a first constituent member 9a and a second constituent member 9b. Similarly, the second telescopic cover 10 includes a first constituent member 10a and a second constituent member 10b. The first constituent members 9a, 10a are fixed to one side and the opposite other side of the table 5 with fixing bolts, and the second constituent members 9b, 10b are fixed to the predetermined regions of the saddle 6 with fixing bolts.

A telescopic cover has a structure in which a plurality of members (cover elements) are combined to form one cover. Therefore, the telescopic cover may have a large mounting error, and requires a more allowance for adjusting the position. However, a method with which both ends of the telescopic cover are fixed directly to a table, saddle, column, or bed cannot ensure a sufficient adjustment allowance in longitudinal, horizontal, and vertical directions. The structure of the telescopic cover is disclosed in Japanese Patent Application Laid-Open No. 7-60593 and Japanese Patent Application Laid-Open No. 2003-236731, but there is no description about mounting and adjustment of the telescopic cover in these prior art techniques.

### SUMMARY OF THE INVENTION

In view of the above-described problems in the prior art techniques, an object of the present invention is accordingly to provide a machine tool having an extendable cover that protects axis driving components against chips generated when the machine tool is used, and has a structure that can ensure a sufficient adjustment allowance for installation on the machine tool.

A machine tool according to the present invention has an extendable cover. The extendable cover is formed by nesting a plurality of cover elements in series so that the extendable cover is telescopic in a movement direction of a movable part of the machine tool. One end of the extendable cover is fixed to the machine tool with a fixing member via a cover supporting member. The cover supporting member has a bent shape in which a cover-fixed surface, which is fixed to the extendable cover, and a machine tool-attached surface, which is attached to the machine tool, cross at a predetermined angle. The cover-fixed surface and machine tool-attached surface have through holes formed in connections with the extendable cover and machine tool, respectively. The through holes have a size that enables adjustment of positioning of the extendable cover with respect to the machine tool in vertical, horizontal, and longitudinal directions.

According to the present invention, it is possible to provide a machine tool having an extendable cover that protects axis driving components against chips generated when the machine tool is used, and has a structure that can ensure a sufficient adjustment allowance for installation on the machine tool.

### BRIEF DESCRIPTION OF THE DRAWINGS

The above and other objects and features of the present invention will be apparent from the following description of embodiments with reference to the appended drawings, in which:

FIGS. 1A and 1B illustrate a first example of a machine tool having a telescopic cover;

FIGS. 2A and 2B illustrate a second example of a machine tool having a telescopic cover;

FIGS. 3A and 3B illustrate a third example of a machine tool having a telescopic cover;

FIGS. 4A to 4C illustrate an example of mounting a telescopic cover of a machine tool according to the present invention; FIG. 4A is a top view, FIG. 4B is a front view, and FIG. 4C is a right side view;

FIGS. 5A and 5B are enlarged views of a cover supporting member shown in FIGS. 4A to 4C; FIG. 5A includes s a top view and a left side view and FIG. 5B is a front view;

FIGS. 6A and 6B illustrate a method of mounting the telescopic cover and cover supporting member; FIG. 6A is a top view and FIG. 6B is a front view;

FIG. 7 is a perspective view illustrating the method of mounting the telescopic cover and cover supporting member;

FIG. 8 is a perspective view illustrating the method of mounting the telescopic cover and cover supporting member; in FIG. 8, the telescopic cover and cover supporting member shown in FIG. 7 are viewed from the lower side;

FIG. 9 is an enlarged view of the cover supporting member;

FIGS. 10A and 10B illustrate installation of the cover supporting member on a movable part (table) of the machine tool;

FIG. 11 illustrates an example of an integrated cover supporting member;

FIG. 12 illustrates an example of a separated cover supporting member (a pair of cover supporting members with bilaterally symmetric shapes are used for each telescopic cover set);

FIG. 13 illustrates an example of a separated cover supporting member (a pair of cover supporting members with bilaterally the same shape are used for each telescopic cover set);

FIG. 14 illustrates an example of the shape of a through hole provided in the cover supporting member or telescopic cover;

FIGS. 15A to 15C illustrate an example of mounting a cover supporting member when the cover supporting member is bent at a predetermined non-right angle; FIG. 15A is a top view, FIG. 15B is a front view, and FIG. 15C is a right side view;

FIG. 16 is an enlarged view of a region circled by an alternate long and short dash line in FIG. 15B;

FIG. 17 illustrates an example of the shape of a cover supporting member when the cover supporting member is not bent at a right angle (but is bent at an obtuse angle); and

FIGS. 18A to 18C illustrate a method of mounting a conventional telescopic cover; FIG. 18A is a top view, FIG. 18B is a front view, and FIG. 18C is a right side view.

### DETAILED DESCRIPTION OF THE PREFERRED EMBODIMENTS

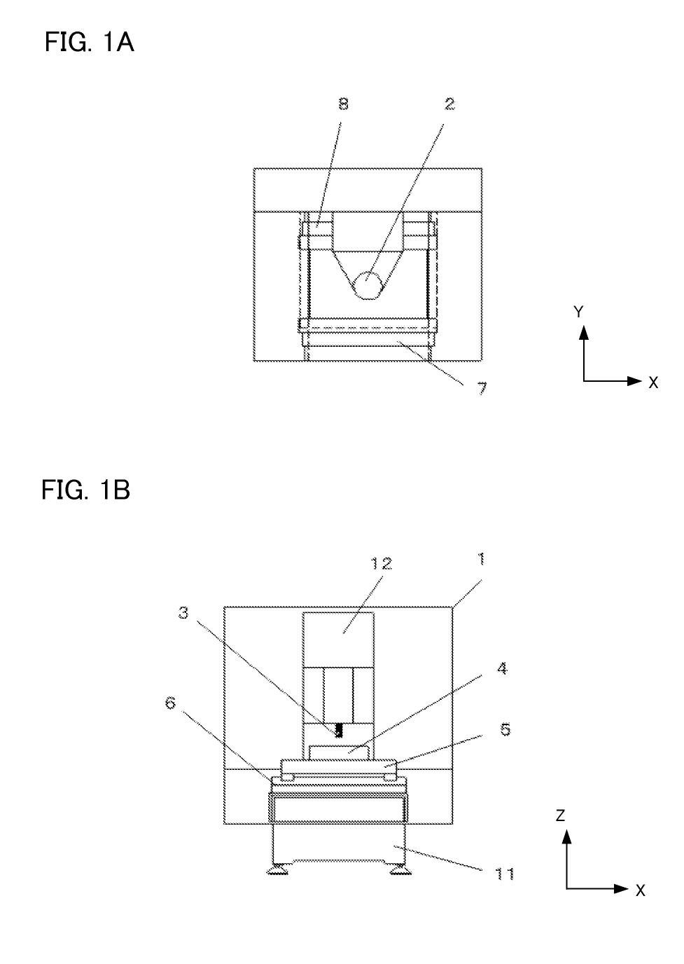

A first example of a machine tool having an extendable cover (telescopic cover) will be described with reference to FIGS. 1A and 1B.

A machining area formed on the upper part of a bed 11 is covered with a splash guard 1. A column 12 with a spindle 2 installed is erected on the bed 11. A tool 3 is attached to the spindle 2. The spindle 2 is controlled liftably with respect to a table 5 (that is, movably in the Z-axis direction). A saddle 6 is supported on the bed 11, and the table 5 is supported on the saddle 6. A workpiece 4 is placed on the table 5. The saddle 6 moves over the bed 11 in the Y-axis direction, and the table 5 moves over the saddle 6 in the X-axis direction, which is orthogonal to the Y-axis.

Reference numerals 7 and 8 denote telescopic covers, which prevent extensive scattering of chips generated and a cutting fluid supplied during machining of the workpiece 4. One end (moving end that interlocks with a movable part of the machine tool) of each cover is attached to the saddle 6, and the other end (fixed end that does not interlock with the movable part of the machine tool) is attached to the bed 11.

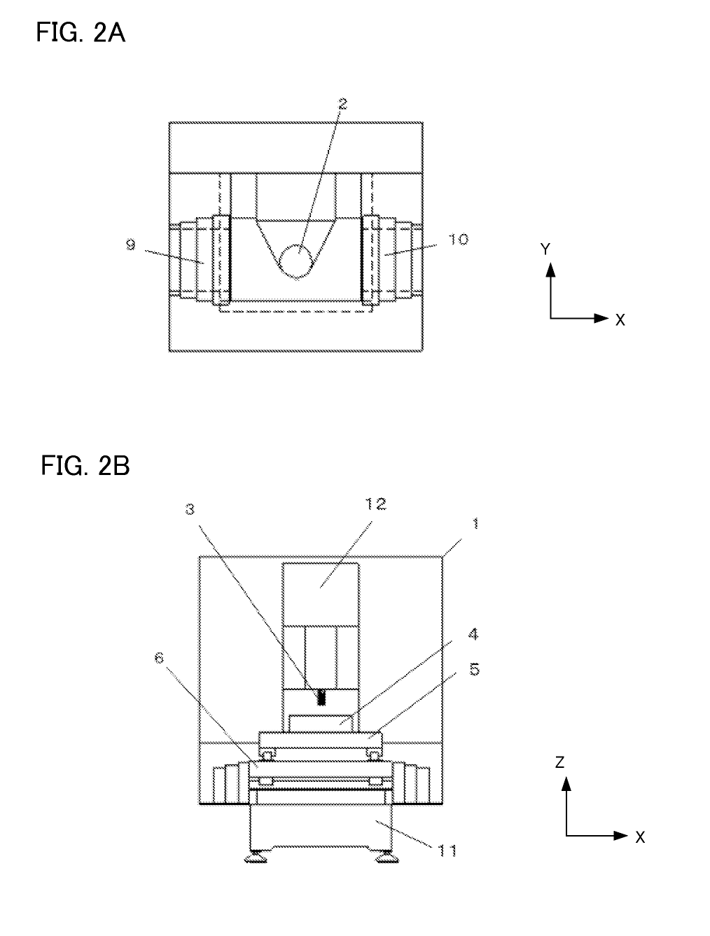

FIGS. 2A and 2B show a second example of a machine tool having an extendable cover (telescopic cover). In this example, the table 5 moves in the Y-axis direction, which is orthogonal to the X-axis. As in the first example in FIGS. 1A and 1B, one end (moving end) of each of telescopic covers 9, 10 is attached to the saddle 6, and the other end (fixed end) is attached to the bed 11.

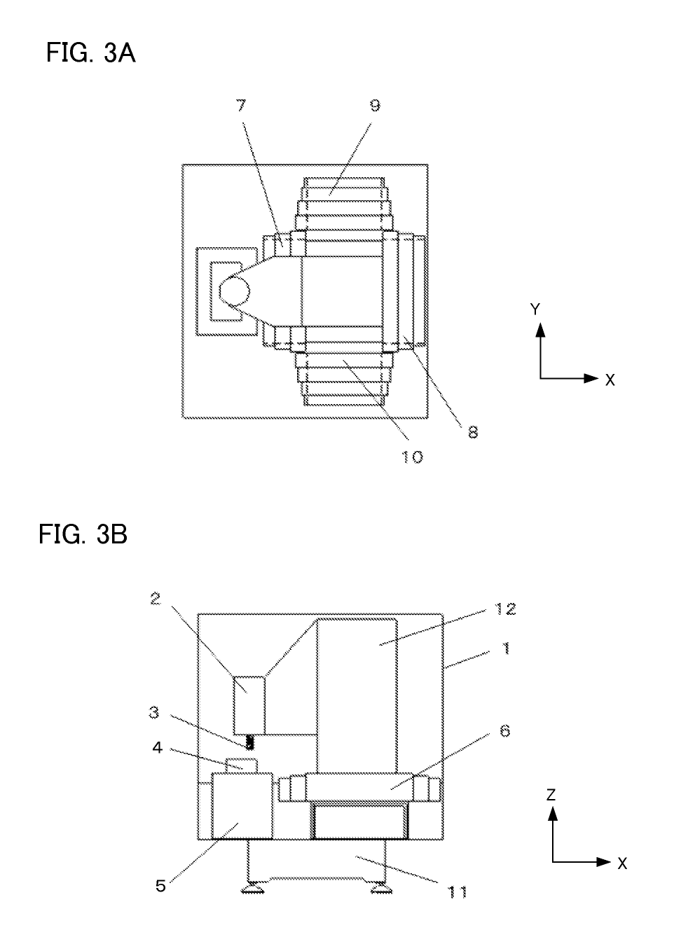

FIGS. 3A and 3B show a third example of a machine tool having an extendable cover (telescopic cover). In this example, the column 12 with the spindle 2 moves in the X- and Y-axis directions. One end (moving end) of each of the telescopic covers 7, 8, 9, and 10 is attached to the column 12, and the other end (fixed end) is attached to the saddle 6 or the bed 11.

Next, mounting of telescopic covers 17, 18 will be described, with an example in which one end (moving end) of each of the telescopic covers 17, 18 that interlocks with a movable part of the machine tool is fixed to the table 5, and the other end (fixed end) that does not interlock with the movable part is fixed to the saddle 6 via a cover supporting member 19.

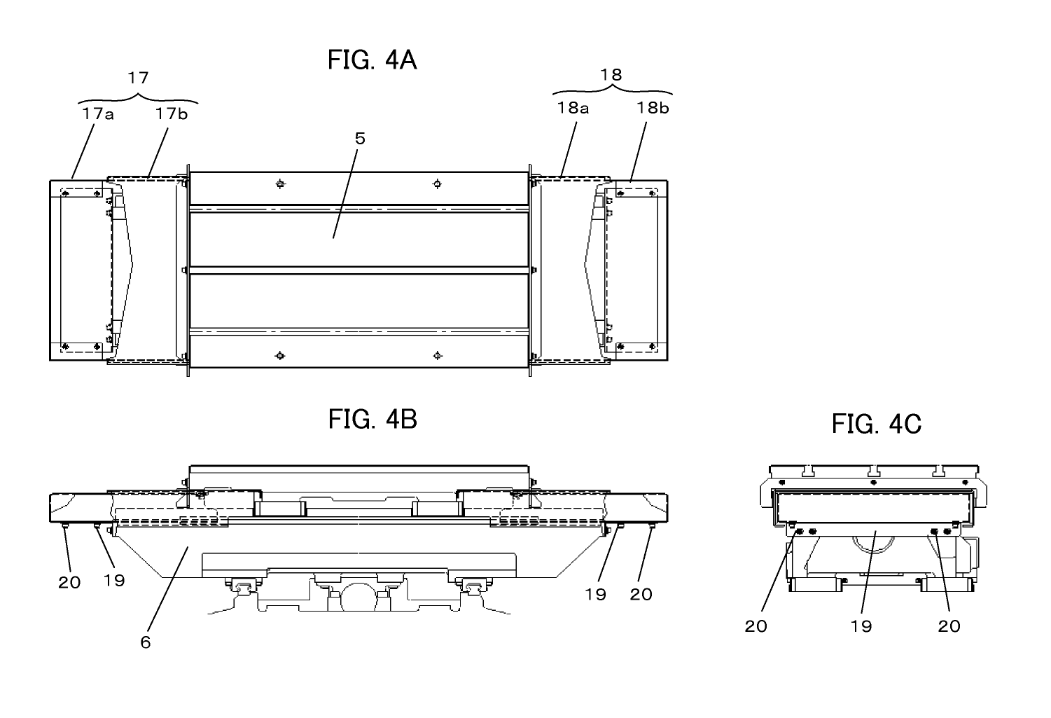

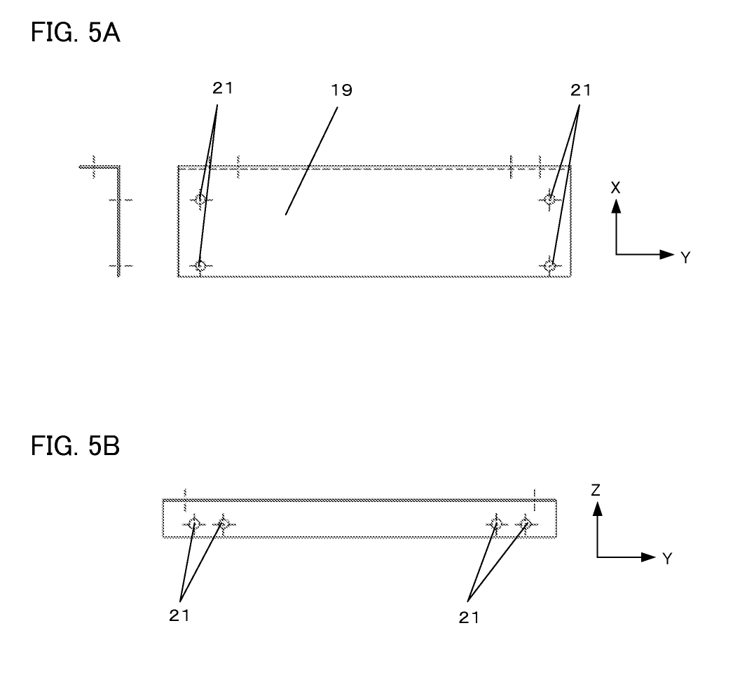

FIGS. 4A to 4C illustrate an example of mounting the telescopic covers 17, 18, and FIGS. 5A and 5B are enlarged views of the cover supporting member 19 shown in FIGS. 4A to 4C.

The telescopic covers 17, 18 include first constituent members (first cover elements) 17a, 18a, and second constituent members (second cover elements) 17b, 18b that are accommodated within the first constituent members 17a, 18a.

As shown in FIG. 5A, the cover supporting member 19 has an L-shaped cross section that is bent at a right angle. The cover supporting member 19 has a cover-fixed surface, which is fixed to the second constituent member 17b or 18b of the telescopic cover 17 or 18, and a saddle-attached surface, which is fixed to the saddle 6. In ranges of gaps between through holes 21 (FIG. 5B) provided in the cover supporting member 19 and fixing bolts 20 that are inserted into the through holes 21, it is possible to adjust the positions of the second constituent members 17b, 18b of the telescopic covers 17, 18 in the longitudinal, vertical, and horizontal directions.

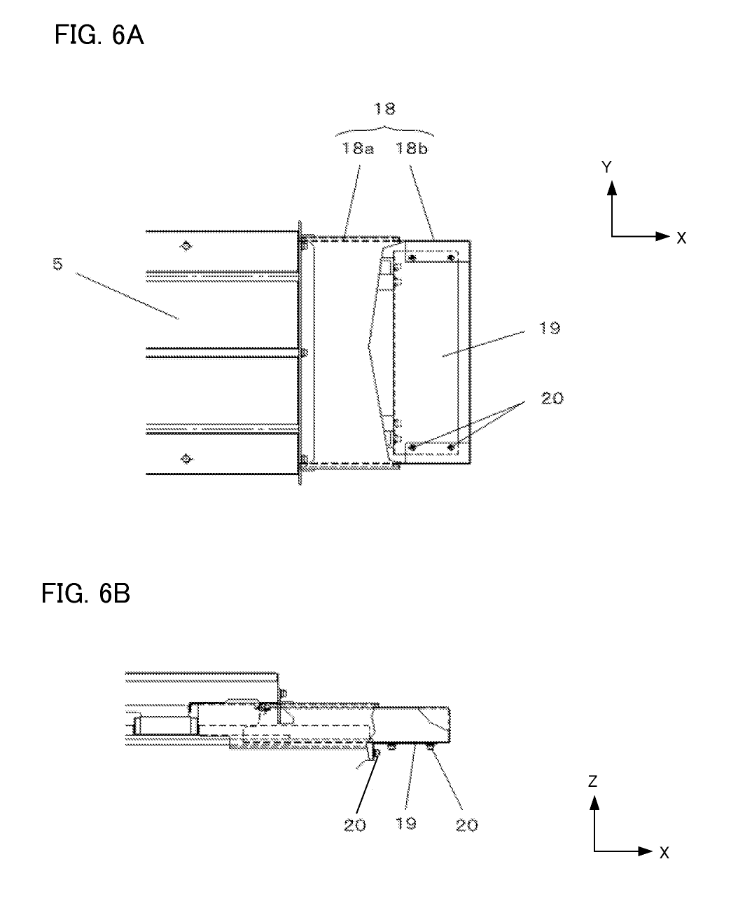

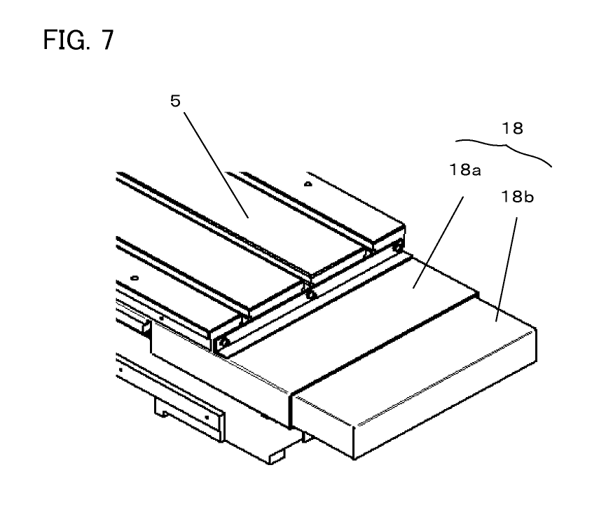

FIGS. 6A to 8 illustrate a method of mounting the telescopic cover and supporting member.

Specific gaps are provided between the first constituent members 17a, 18a and the second constituent members 17b, 18b of the telescopic covers 17, 18. The gaps are large enough to enable smooth relative movement of these constituent members.

First, the first constituent members 17a, 18a of the telescopic covers 17, 18 are fixed to one side and the opposite other side of the table 5.

At this time, gaps between fixing through holes (not shown) provided in the first constituent members 17a, 18a and fixing bolts (not shown) screwed into screw holes (not shown) in the table 5 through the through holes are adjustment allowances for attachment of the first constituent members 17a, 18a (that is, first ends of the telescopic covers 17, 18) within the attached surfaces in the horizontal and vertical directions.

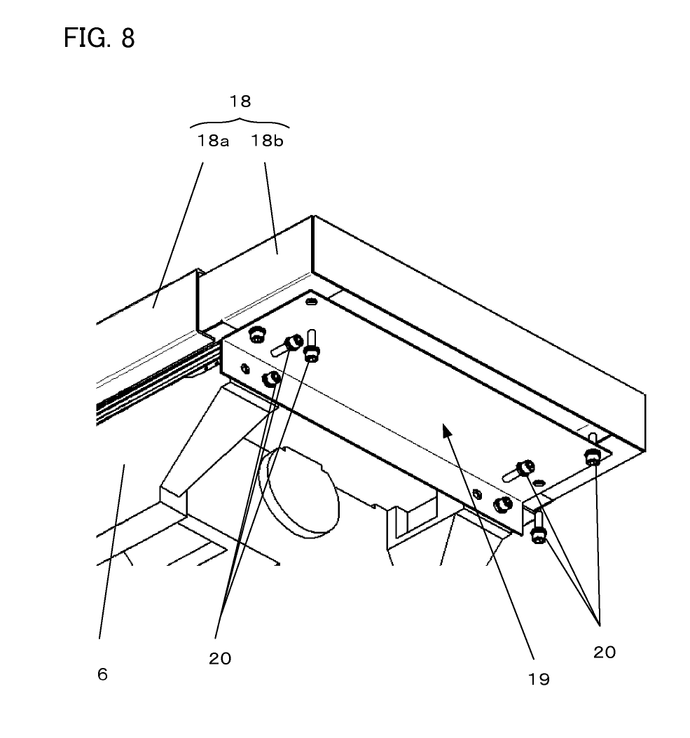

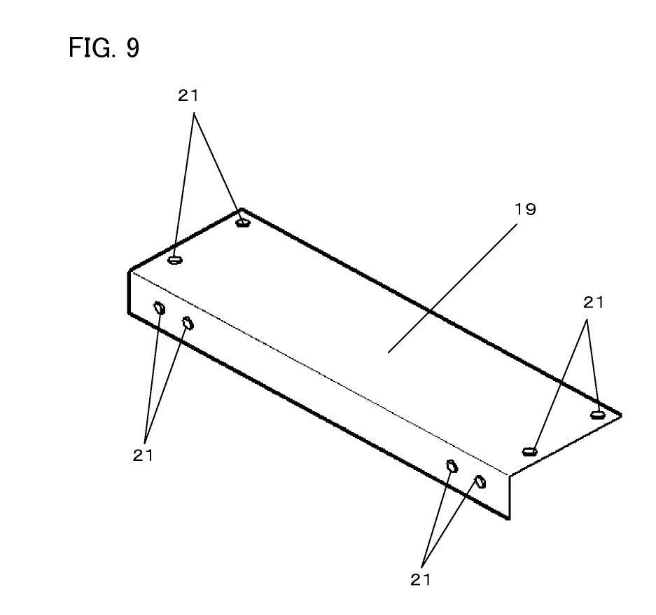

Next, the cover supporting members 19 that are used to support the second constituent members 17b, 18b of the telescopic covers 17, 18 are temporarily fixed to sides of the saddle 6 as shown in FIG. 8. At this time, gaps between the fixing through holes 21 (FIG. 5A) provided in the cover supporting members 19 and the fixing bolts 20 screwed into screw holes (not shown) in the second constituent members 17b, 18b through the through holes 21 are adjustment allowances for attachment of the cover supporting members 19 within the attached surfaces in the horizontal and vertical directions.

Next, the second constituent members 17b, 18b of the telescopic covers 17, 18 are temporarily fixed to the cover supporting members 19 that have already been fixed to the saddle 6. At this time, gaps between the fixing through holes 21 provided in the cover supporting members 19 and the fixing bolts 20 inserted into screw holes (not shown) in the second constituent members 17b, 18b through the through holes 21 are adjustment allowances for attachment of the second constituent members 17b, 18b of the telescopic covers 17, 18 within the attached surfaces in the horizontal direction.

Then, the table 5 is moved to both ends of a moving stroke, and then moved to a position at which the telescopic covers 17, 18 are in the most contracted state while the extension and contraction motion of the telescopic covers 17, 18 in response to that movement is being checked. When the telescopic covers 17, 18 work smoothly while the table 5 is being moved, the installation of the telescopic covers 17, 18 is finished by completely fixing the cover supporting members 19 and the constituent members 17b, 18b that have been temporarily fixed.

While the table 5 is being moved, however, if the telescopic covers 17, 18 do not work smoothly in response to that movement (for example, if the first constituent members 17a, 18a and the second constituent members 17b, 18b rub against each other), the positions of the first constituent members 17a, 18a and the second constituent members 17b, 18b of the telescopic covers 17, 18 and the cover supporting members 19 are adjusted in ranges of above-described adjustment allowances. Then, the table 5 is moved again to both ends of the moving stroke, and then moved to a position at which the telescopic covers 17, 18 are in the most contracted state while the extension and contraction motion of the telescopic covers 17, 18 is being checked. While the table 5 is being moved, the extension and contraction motion of the telescopic covers 17, 18 is checked. When the telescopic covers 17, 18 work smoothly, the installation of the telescopic covers 17, 18 is finished by completely fixing the first constituent members 17a, 18a and the second constituent members 17b, 18b of the telescopic covers 17, 18 and the cover supporting members 19.

The above task is repeated until the telescopic covers 17, 18 work smoothly while the table 5 is being moved.

As described above, the telescopic covers 17, 18 have a configuration in which one end (moving end) of each cover that interlocks with a movable part of the machine tool is fixed to the table 5, and the other end (fixed end) that does not interlock with the movable part is fixed to the saddle 6 via the cover supporting member 19. However, the telescopic covers 17, 18 are not limited to this configuration; it is also possible to use a configuration in which the moving end is fixed to the saddle 6 and the fixed end is fixed to the bed 11 (examples in FIGS. 1A and 1B and FIGS. 2A and 2B), or the moving end is fixed to the column 12 and the fixed end is fixed to the saddle 6 or the bed 11 (example in FIGS. 3A and 3B).

In addition, it is also possible to use a configuration in which the first constituent members 17a, 18a of the telescopic covers 17, 18 are fixed ends, and the second constituent members 17b, 18b that are accommodated within the first constituent members 17a, 18a are moving ends.

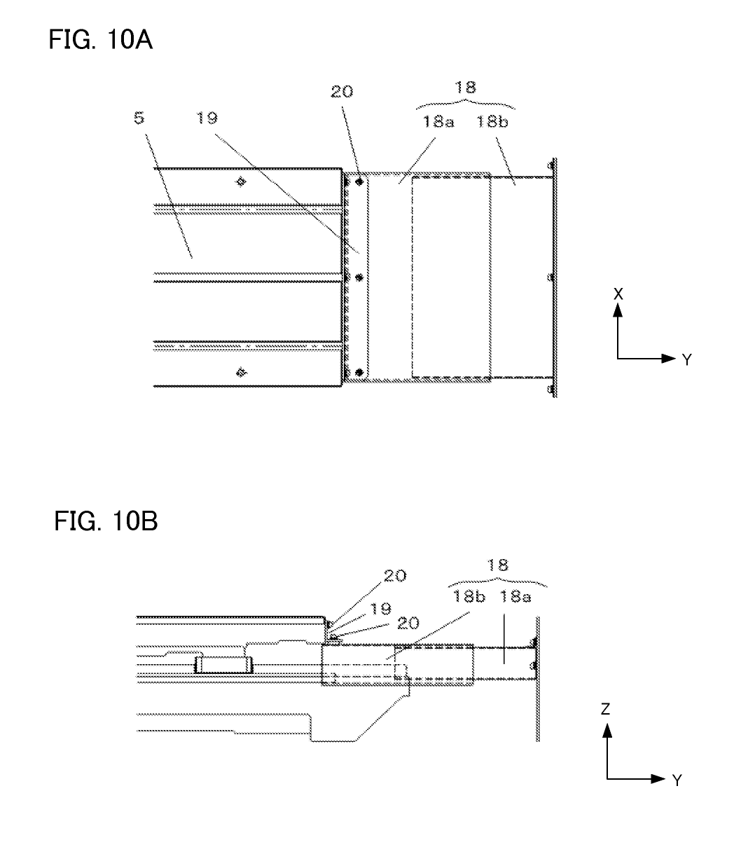

An example shown in FIGS. 10A and 10B illustrates a configuration in which the telescopic covers 17, 18 are fixed to the movable part side (table 5 side) of the machine tool via the cover supporting members 19. In this example, the cover supporting members 19 can be moved (with the through holes 21 and the bolts 20 as described above) with respect to the table 5 in the Z- and Y-axis directions. The first constituent members 17a, 18a, which are moving ends of the telescopic covers 17, 18, can be moved (with the through holes and the bolts in a similar manner) with respect to the cover supporting members 19 in the X- and Y-axis directions. The second constituent members 17b, 18b, which are fixed ends of the telescopic covers 17, 18, can be moved (with the through holes and the bolts in a similar manner) with respect to a fixed part (for example, the splash guard 1) of the machine tool in the Z- and X-axis directions.

An example of the shape of the cover supporting member 19 will now be described.

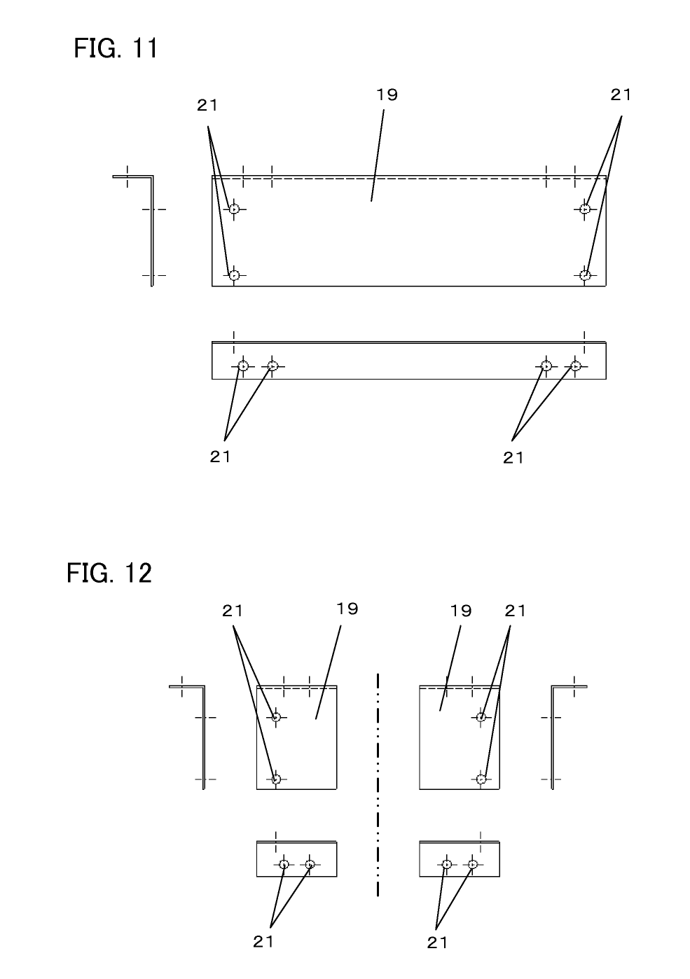

FIG. 11 illustrates an example of an integrated cover supporting member 19. The cover supporting member 19 has an L-shaped cross section that is bent at a right angle. One cover supporting member 19 is used for each telescopic cover set.

FIG. 12 illustrates an example of a separated cover supporting member 19. The cover supporting member 19 has an L-shaped cross section that is bent at a right angle. A pair of the cover supporting members 19 with bilaterally symmetric shapes are used for each telescopic cover set.

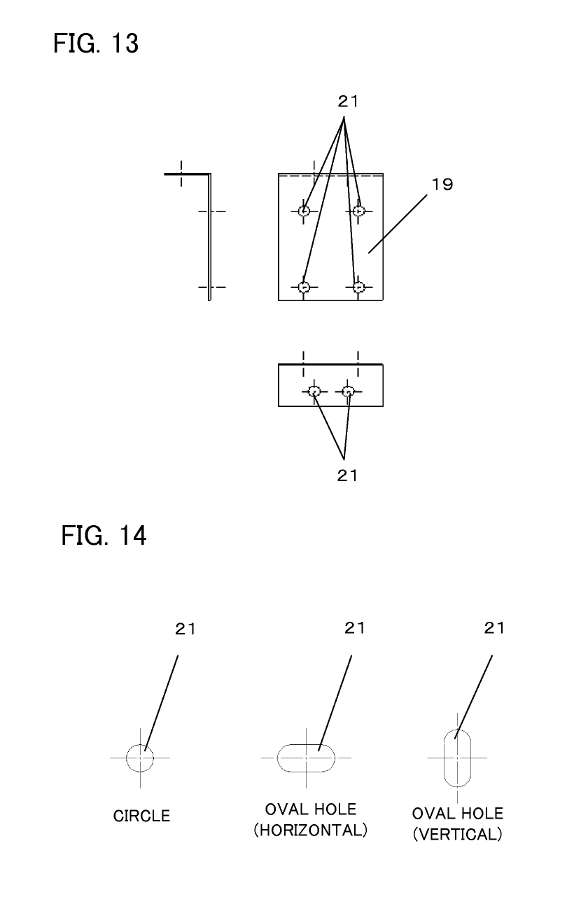

FIG. 13 illustrates an example of a separated and common cover supporting member 19. The cover supporting member 19 has an L-shaped cross section that is bent at a right angle. That is, the cover supporting member 19 of this type is separated as shown in FIG. 12, but two separated supporting members have the same shape. Two cover supporting members 19 are used for each telescopic cover set.

Next, the through holes 21 provided in the cover supporting member 19 or the telescopic covers 17, 18 will be described with FIG. 14.

The fixing through holes 21 provided in the cover supporting member 19 may have a shape of a circle or oval hole (horizontal or vertical), or may also have another shape. If the through holes 21 are circular holes, gaps between the fixing through holes 21 and the fixing bolts 20 are equal in all directions. If the through holes 21 are oval holes, these gaps are unequal in different directions. When the telescopic covers 17, 18 are mounted on the machine tool and adjusted, it is possible to ensure wider adjustment allowances than in the prior art techniques. This has effects of optimizing the motion of the telescopic covers 17, 18, and finally mounting the telescopic covers 17, 18 easily without the need to make repeated adjustments.

All examples of the above cover supporting members 19 have a cross section that is bent at a right angle (L-shaped). However, the cover supporting member 19 is not limited to this shape.

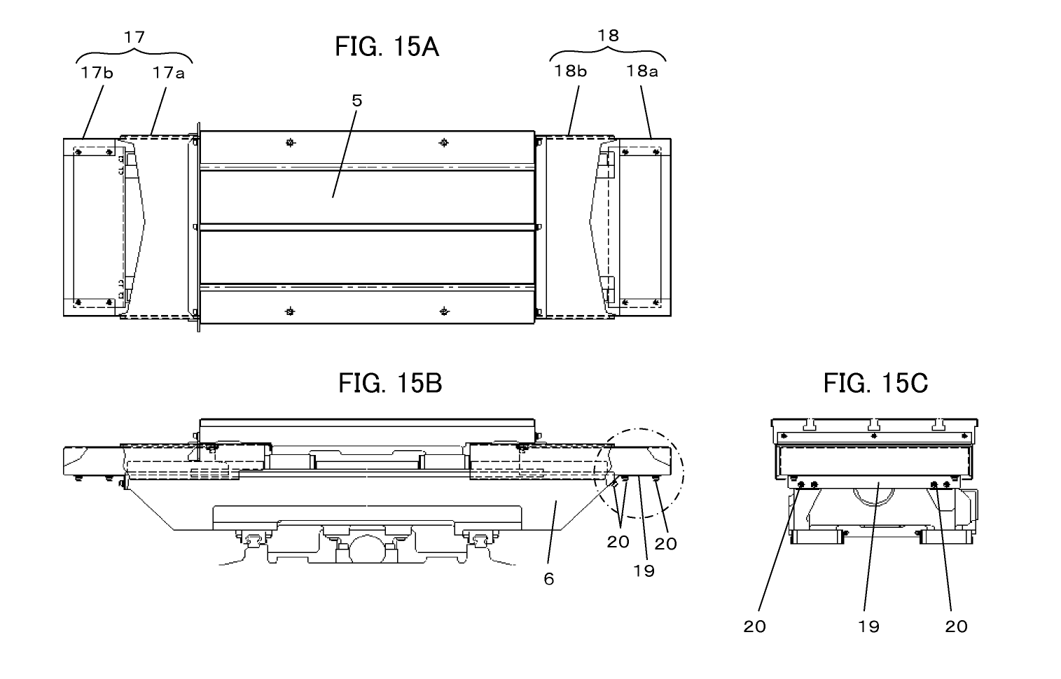

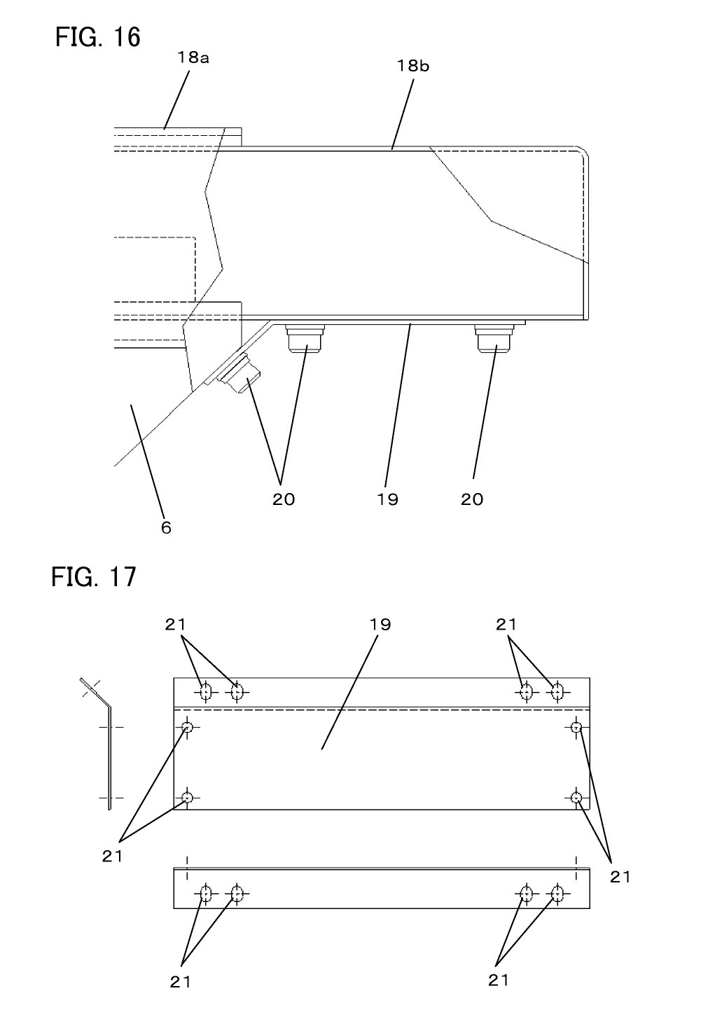

FIGS. 15A to 17 illustrate an example of mounting a cover supporting member 19 when the cover supporting member 19 is bent at a predetermined non-right angle.

To enable the cover supporting member 19 to be fixed to a tilted surface of the saddle 6, the cover supporting member 19 has a shape that is bent at an obtuse angle. The through holes 21 into which the fixing bolts 20 are to be inserted are provided in the cover supporting member 19. For adjustment during the installation task, the through holes 21 have different shapes in different regions. FIG. 17 illustrates an example of the shape of the cover supporting member 19 when the cover supporting member 19 is bent at an obtuse angle, instead of at a right angle.

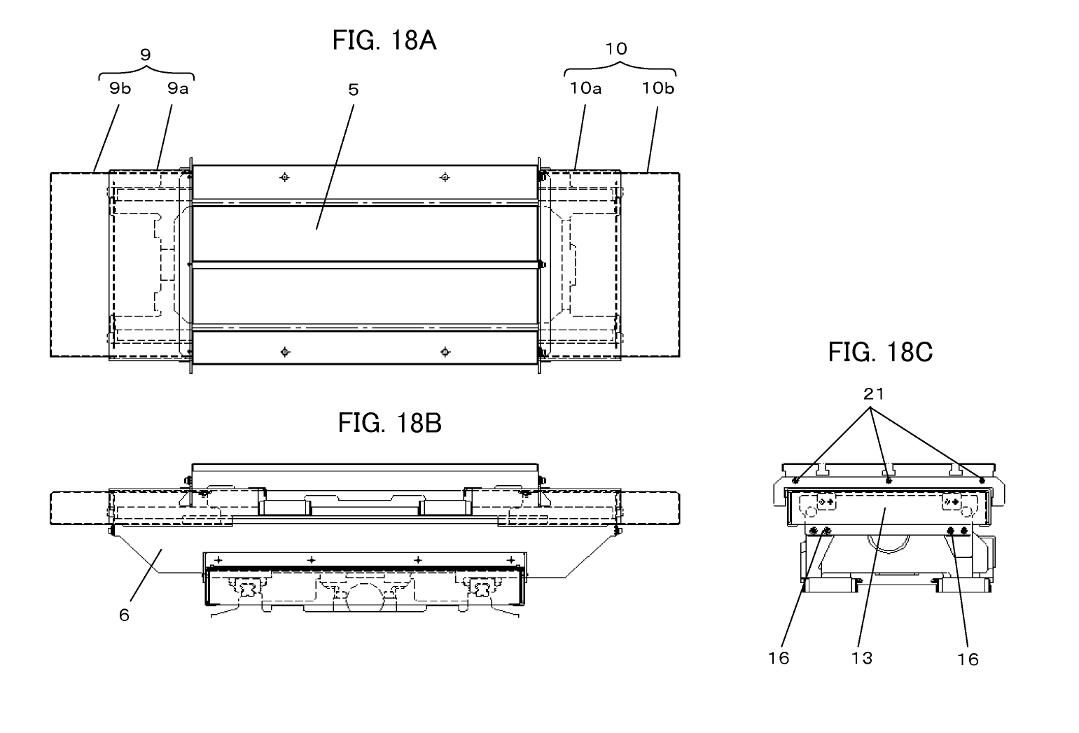

FIGS. 18A to 18C illustrate a method of mounting a conventional telescopic cover.

One ends (first constituent members 9a, 10a) of the telescopic covers 9, 10 are fixed to the table 5 supported on the saddle 6 with fixing bolts 16. The other ends (second constituent members 9b, 10b) of the telescopic covers 9, 10 are fixed to the table 5 with the fixing bolts 16, or fixed via supporting members 13 in some cases.

1. A machine tool comprising:
an extendable cover, wherein
the extendable cover is formed by nesting a plurality of cover elements in series so that the extendable cover is telescopic in a movement direction of a movable part of the machine tool,
one end of the extendable cover is fixed to the machine tool with a fixing member via a cover supporting member,
the cover supporting member has a bent shape in which a cover-fixed surface, which is fixed to the extendable cover, and a machine tool-attached surface, which is attached to the machine tool, cross at a predetermined angle,
the cover-fixed surface and machine tool-attached surface have through holes formed in connections with the extendable cover and machine tool, respectively, and
the through holes have a size that enables adjustment of positioning of the extendable cover with respect to the machine tool in vertical, horizontal, and longitudinal directions.

2. The machine tool having the extendable cover according to claim 1, wherein a gap between the fixing member and through hole is provided equally in all directions.

3. The machine tool having the extendable cover according to claim 1, wherein a gap between the fixing member and through hole is different in each direction.
